(19) United States
(12) Patent Application Publication
(10) Pub. No.: US 2003/0228068 A1
(43) Pub. Date: Dec. 11, 2003

(54) Progressive transmission and reception of image data using modified hadamard transform

(75) Inventors: Soma Sekhar Dhavala, Bangalore (IN); John Erik Hershey, Ballston Lake, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 10/166,989

(22) Filed: Jun. 11, 2002

(51) Int. Cl. G06K 9/36

(52) U.S. Cl. 382/281

(57) ABSTRACT

An image data transceiver system includes an encoder for converting original image data into processed image data and for transmitting the processed image data. The encoder includes a forward transformation block, having a Modified Hadamard Transform basis for compressing the original image data and for converting original image data into transformed image data. The encoder also includes a progressive transmission block for progressively transmitting the processed image data. The image transceiver system includes a decoder for reconstructing the original image data from the processed image data transmitted by the encoder. A progressive reconstruction block in the decoder progressively reconstructs the transformed image data from processed image data; and an inverse transformation block in the decoder has an inverse Modified Hadamard Transform basis for extracting the original image data from the transformed image data.

### BACKGROUND OF THE INVENTION

The present invention relates generally to transmission and reception of image data, and more particularly to a method and system for progressively transmitting and receiving image data using a Modified Hadamard Transform to achieve both compression and robustness, and to avoid loss or corruption of data due to channel errors.

Image data compression is concerned with the reduction of the number of bits required to transmit and store original image data. This is possible if the raw data contains redundant information. Redundancy can be of different forms, such as spatial or temporal. In case of spatial redundancy, the image surface is smooth (i.e., with minimal variation between picture elements) and it is not necessary to have the entire information sent to reconstruct the original image. Temporal redundancy is useful in video sequencing and, similarly, it is not necessary to have each frame of the video sequence to reconstruct the image set. When the raw data contains redundant information, the removal of redundancy helps to compress the image data or image information, leading to faster transmission and reconstruction of the image.

Many techniques exist to remove redundancy. Transform domain coding is one such technique where one image is mapped with another image to compress the original image. Mapping is termed as transformation and it satisfies certain properties required for image compression. In transform domain coding the original image data source is transformed into a domain where the energy is compacted into a small region of a frequency spectrum, e.g., through techniques sometimes referred to as Discrete Cosine transform (DCT), Discrete Sine transform (DST), Wavelet transform, Hadamard Transform, Modified Hadamard Transform, and so forth. In general, a Hadamard Transform is a mapping technique which spreads the energy uniformly in a given frequency spectrum. The objective of transform domain coding is to contain signal information into a smaller number of coefficients (i.e. to compact or compress the information). The consequence of the compact representation is a trade-off with the robustness of the transform domain representation or the final image quality. For example, in the case of DCT, in general, the compression is good and the DC component has maximum energy. However, when this component is corrupted the reconstructed image may have poor visual quality. Whereas as Hadamard Transform is more robust to error reconciliation (affecting the quality of image), such transforms do not compress as well as DCT does.

It would therefore be desirable to have a transform, which provides reasonable compression and robustness at the same time.

### BRIEF DESCRIPTION OF THE INVENTION

Preferred embodiments of the invention provide an image data compression technique exhibiting reasonable compression and robustness of the image for transmission and reconstruction. The technique may be used in a variety of settings, such as for image data compression in medical imaging, general purpose imaging, scanning for retransmission, telemedicine, quick browsing of image database, transmission of image across noisy channels. The technique would work for general data transmission as well.

The present technique uses an approach of applying a suitable transform to obtain the balance between removal of redundancy and preservation of redundancy. A preferred transform is a Modified Hadamard Transform for progressive transmission of image data which spreads the energy of the transformed image data over a broad range. In particular, the member functions of the basis functions of the Modified Hadamard Transform spread the approximation error over a relatively broad spectrum. Application of these basis functions for image data or signal representation makes the transmission robust compared to the existing methods. Since the energy is distributed in wider bands, the corruption of a particular component will spread the error equally in the spatial domain. Hence, the visual or perceptual quality is better when compared to a transform which has more compactness. However, the transform should not overcompensate the compression for the sake of robustness, in which case the original image data can be directly sent without the application of the transform. When the transmission channel has limited bandwidth, it becomes increasingly desirable to send image data in the order in which perceptual quality improves progressively.

Briefly, in accordance with one embodiment of the invention, an image data transceiver system comprises an encoder for converting original image data into transformed image data. The transformed image data is converted to intermediate image data, and finally converted into processed image data. The encoder is also adapted for transmitting the processed image data once obtained. A decoder is provided for reconstructing the original image data from transformed image data. Transformed image data is obtained from intermediate image data which in turn is obtained from processed image data transmitted from the encoder. The encoder comprises a forward transformation block for implementing a Modified Hadamard Transform as a basis for original image data compression and for converting original image data into transformed image data. The encoder also includes a progressive transmission block for progressively transmitting the processed image data. The decoder includes a progressive reconstruction block for progressively reconstructing the transformed image data from the processed image data; and an inverse transformation block, which implements an inverse Modified Hadamard Transform basis for extracting the original image data from the transformed image data.

In accordance with another aspect of the present technique, a method of transmitting original image data comprises converting original image data into transformed image data, converting transformed image data into intermediate image data and, finally, converting intermediate image data into processed image data and for transmitting the processed image data. This method of transmitting original image data further comprises applying a Modified Hadamard Transform basis to original image data for image data compression, processing the transformed image data, and converting it into intermediate image data, wherein a plurality of coefficients are generated by using a forward successive approximation loop and a method of applying entropy coding to intermediate image data originating from the forward successive approximation loop. The forward successive approximation loop comprises a set of transmission variables for progressively updating the intermediate image data.

In accordance with another aspect of the present technique, a method of receiving processed image data comprises a method for reconstructing original image data from transformed image data, obtaining transformed image data from intermediate image data, and obtaining intermediate image data from processed image data received from an encoder. This method of receiving processed image data further comprises receiving a plurality of coefficients from processed image data of an image data transmitting system, applying entropy decoding to intermediate image data, progressively updating the coefficients of the intermediate image data by using an inverse successive approximation loop at a decoder, and converting back to transformed image data. Again, an inverse Modified Hadamard Transform is applied for reconstructing the original image data from the transformed image data.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a system block diagram of an image data transceiver system according to one embodiment of the invention;

FIG. 2 illustrates an encoder useful in an image data transceiver, such as that of FIG. 1, and further illustrates the flow diagram for processing original image data into processed image data and transmitting the processed image data; and

FIG. 3 illustrates a decoder useful in an image data transceiver, such as that of FIG. 1, and further illustrates the flow diagram for reconstructing original image data from the processed image data received from the encoder.

### DETAILED DESCRIPTION OF THE INVENTION

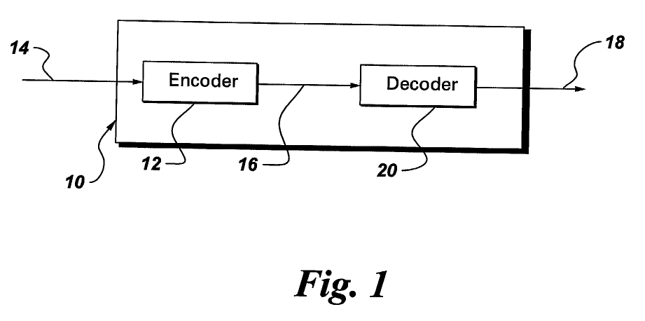

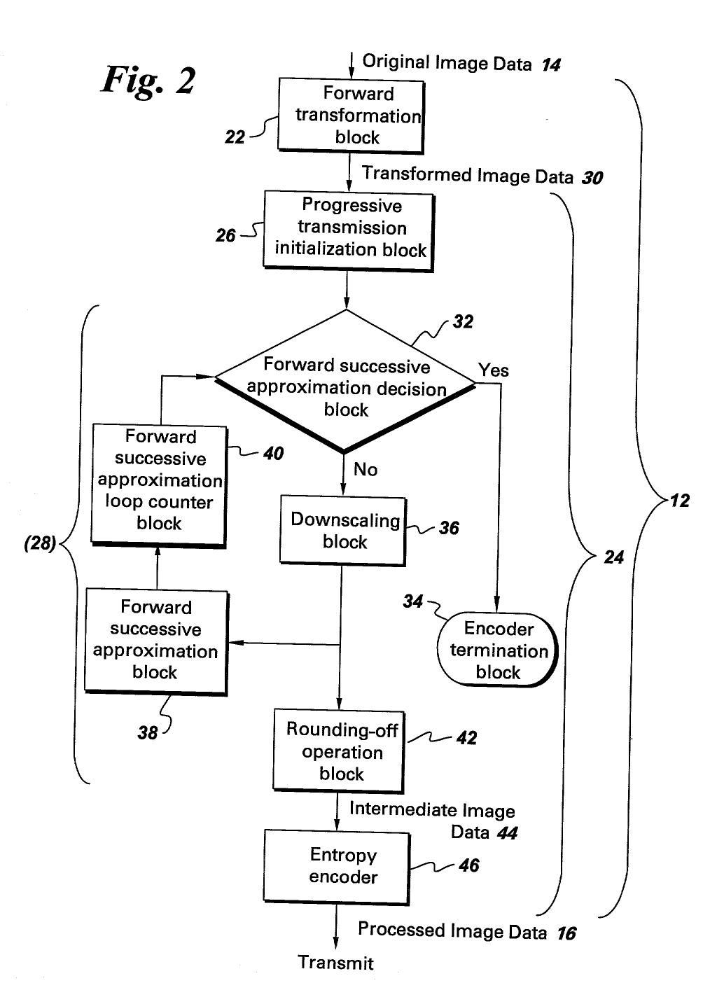

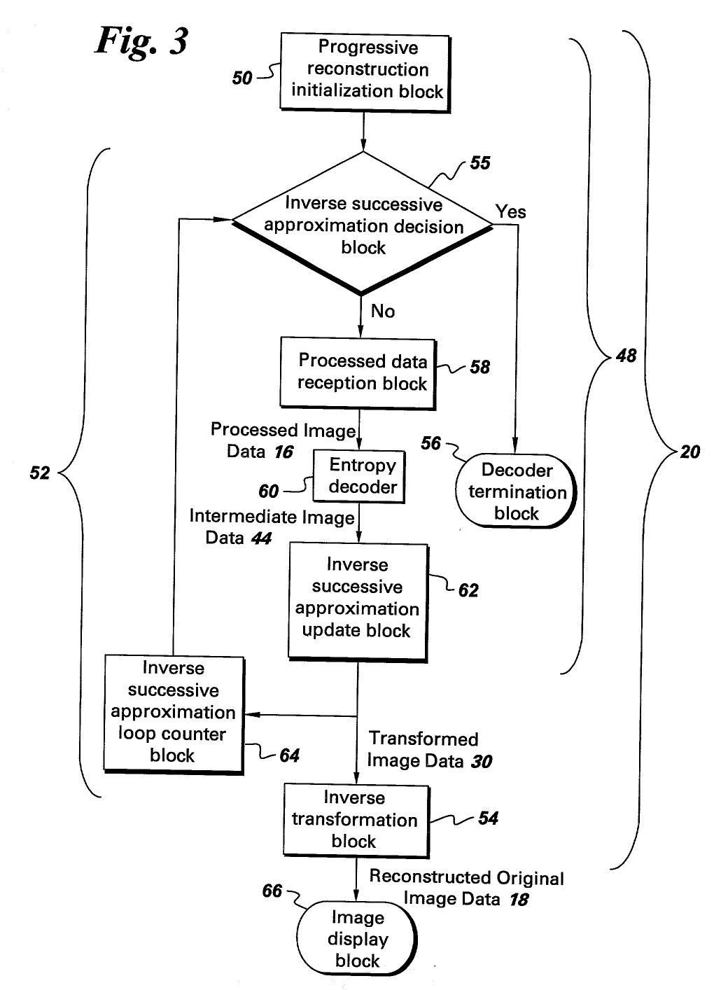

FIG. 1 illustrates an image data transceiver system 10 in accordance with one embodiment of the present invention. System 10 comprises an encoder 12, as illustrated in FIG. 2, for converting original image data 14 into transformed image data 30, which is converted to intermediate image data 44 and finally converted into processed image data 16. The encoder 12 is also configured for transmitting said processed image data. System 10 also comprises a decoder 20, as illustrated in FIG. 3, for obtaining reconstructed original image data 18 from the transformed image data 30. Transformed image data 30 is obtained from the intermediate image data 44, intermediate image data 44 is obtained from processed image data 16 received from the encoder 12.

The processes being carried out in encoder 12 are illustrated in the flow diagram in FIG. 2. The encoder 12 comprises a forward transformation block 22 and a progressive transmission block 24.

The forward transformation block 22 includes a Modified Hadamard Transform basis for compressing original image data 14 and for converting the original image data 14 into transformed image data 30. The Modified Hadamard Transform basis comprises a two dimensional basis function constructed from separable one dimensional basis functions. A coefficient matrix A containing a plurality of coefficients is generated using the Modified Hadamard Transform.

The primary step in transform coding in block 22 is the selection of the length of the basis function. Most of the transform domain techniques work on blocks of size 8×8.

An 8-point Modified Hadamard Transform described is given by

$$Y = ( \begin{matrix}0.6407 & 0.2250 & 0.1503 & 0.1274 & 0.1274 & 0.1503 & 0.2250 & 0.6407 \\ 0.6407 & - 0.2250 & 0.1503 & - 0.1274 & 0.1274 & - 0.1503 & 0.2250 & - 0.6407 \\ 0.2654 & 0.5432 & - 0.3629 & - 0.0528 & 0.0528 & 0.3629 & - 0.5432 & - 0.2654 \\ 0.2654 & - 0.5432 & - 0.3629 & 0.0528 & 0.0528 & - 0.3629 & - 0.5432 & 0.2654 \\ 0.1274 & 0.1503 & 0.2250 & 0.6407 & - 0.6407 & - 0.2250 & - 0.1503 & - 0.1274 \\ 0.1274 & - 0.1503 & 0.2250 & - 0.6407 & - 0.6407 & 0.2250 & - 0.1503 & 0.1274 \\ 0.0528 & 0.3629 & - 0.5432 & - 0.2654 & - 0.2654 & - 0.5432 & 0.3629 & 0.0528 \\ 0.0528 & - 0.3629 & - 0.5432 & 0.2654 & - 0.2654 & 0.5432 & 0.3629 & - 0.0528\end{matrix} )$$

Let X be 8×8 block of the image and Y be the basis generated above. Then the forward transform is computed as:

A=YXY^{T} (1),

where A is the coefficient matrix containing a plurality of coefficients. The coefficient matrix is the output of the forward Modified Hadamard Transform block as given in equation (1).

Here, the two-dimensional basis function is constructed from separable one-dimensional basis functions by doing row filtering followed by column filtering. This scheme is particularly attractive in terms of computation. The transform is unitary i.e. YₙYₙ^{T}=1 where (.)^{T} is the transpose operator and I is the identity matrix.

Progressive transmission block 24 is used for progressively transmitting the processed image data 16. The progressive transmission block 24, comprises a forward successive approximation loop 28, a progressive transmission initialization block 26 and an entropy encoder 46.

The progressive transmission initialization block 26 is used for generating and initializing the transmission variables used in the successive approximation loop.

The forward successive approximation loop 28 is used for processing the transformed image data 30 and converting it into intermediate image data 44. The forward successive approximation loop 28 comprises a forward successive approximation decision block 32 for checking whether all the transformed image data 30 has been converted into intermediate image data or not. If the answer is yes then the operation in forward successive approximation loop 28 is complete and is terminated in the encoder termination block 34. If the answer is no, then the coefficients are downscaled in the downscaling block 36. In the forward successive approximation loop counter block 40, the loop counter is progressively reduced by unity that is the scaling factor is reduced by unity progressively in the forward successive approximation loop counter block. In the forward successive approximation block 38 the coefficients are updated progressively. The rounding-off operation block 42 rounds off the coefficients and generates the intermediate image data 44.

Forward successive approximation is a process by which transformed image data can be sent in a progressive manner. The step of progressively transmitting the image data comprises downscaling and updating of the coefficients for transmitting the transformed image data 30 progressively in the forward successive approximation loop 28 and converting transformed image data 30 into intermediate image data 44.

An entropy encoder 46 is used for assigning a plurality of bits to the intermediate image data 44, processed by the forward successive approximation loop 28, to convert intermediate image data 44 into processed image data 16.

The successive approximation technique applied to the Modified Hadamard Transform is detailed below.

Let A be the coefficient matrix as mentioned in equation (1) above and generated in the forward transformation block 22, M be the total number of transmissions (M determines the scaling factor) required to send a plurality of coefficients and B be a temporary matrix for storing intermediate results. Then the downscaling step, as performed in downscaling block 36, is given by,

A=└(A−B)/2′┘ (2),

where, └A┘ is entropy coded in the entropy encoder 46 and transmitted as processed image data 16 to the decoder 20 or a reception system and i is the forward successive approximation loop counter variable initialized in the forward successive approximation block 32 and decremented in the forward successive approximation lop counter block 40. Here └ ┘ represents a rounding off operation, that is, the step carried out in rounding-off operation block 42. This is the processed image data 16 received at the decoder 20.

The next step is to update the coefficient matrix A and temporary matrix B as:

A=A2′ and B=└A┘2′ (3)

This step carried out in forward successive approximation block 38. And now the forward successive approximation loop counter is decremented by one.

i=i−1 (4)

Downscaling in general refers to division of a quantity by an integer number. Upscaling in general refers to multiplication of a quantity by an integer number.

Progressive reduction of the scaling factor as shown in equation (4) is represented in the forward successive approximation as loop counter i.

Initialization at progressive transmission initialization block 26 involves the progressive transmission variables, M (related to the number of bit planes), B (a temporary matrix for storing intermediate results) and i (the forward successive approximation loop counter) which are set to the following values: “number of bit planes in the data-1”, “zero” and “M” respectively. The loop counter is decremented every time by one. This is equivalent to reducing the scaling factor 2^{M} to 2^{M-1}, as defined in equation (3).

The number of bit planes as referred above is given by the expression [log₂(max (A)], where [ ] is the ceiling operation and max (A) is the coefficient in A that has maximum magnitude. The entropy encoder allocates a specified number of bits to each possible coefficient based on its probability.

Another aspect of the present technique comprises a method of transmitting original image data 14 by converting original image data 14 into transformed image data 30; converting transformed image data 30 into intermediate image data 44; and finally converting intermediate image data 44 into processed image data 16 and transmitting the processed image data, as illustrated in FIG. 2. Progressive transmission is a method for sending the information in such a way that the level of detail increases every time the data is received. In the case of image data, the visual quality increases every time if the data is transmitted in this manner.

The processes performed by decoder 20 are illustrated in the flow diagram in FIG. 3. At the decoder, the reconstructed original image 18 is obtained from transformed image data 30. Transformed image data 30 is obtained from intermediate image data 44, intermediate image data 44 being obtained from processed image data 16 transmitted from encoder 12.

The decoder 20 comprises a progressive reconstruction block 48 and an inverse transformation block 54.

The progressive reconstruction block 48 is used for progressively reconstructing the transformed image data 30. The progressive reconstruction block 48 comprises a progressive reconstruction initialization block 50 and an inverse successive approximation loop 52.

The progressive reconstruction initialization block 50 is used for initializing the reception variables used in the inverse successive approximation loop 52.

Initialization at progressive reconstruction initialization block 50 involves progressive reception variables M (related to the number of bit planes), D (a temporary matrix for storing intermediate results) and j (loop counter) which are set to the following values; “number of bit planes in the data-1”, “zero” and “zero”, respectively. The loop counter is incremented every time by one. This is equivalent to reducing the scaling factor 2^{M} to 2^{M-1}.

Inverse successive approximation loop 52 comprises an inverse successive approximation decision block 55 to check whether the transformed image data 30 has been completely reconstructed as reconstructed original image data 18 or not. If it has been completely reconstructed, the process ends at a decoder termination block 56.

The processed image data 16 is received at the decoder 20 in a processed data reception block 58. It is first entropy-decoded in an entropy decoder 60 to get └A┘, i.e, the intermediate image data 44 that is stored in C. C is a variable that represents storing intermediate image data 44 at entropy decoder 60. The entropy decoder 60 decodes the outcome based on the bits allocated to it by the entropy encoder 46.

Then the transformed image data 30 is progressively reconstructed from the intermediate image data 44 as:

D=C2^{M-j} (5)

and

A_{c}=A_{c}+D (6)

D and A_{c} are used in inverse successive approximation update block 62 for upscaling and updating of the coefficients.

The inverse successive approximation loop 52 comprises an inverse successive approximation updating block 62 for progressively updating the coefficients of intermediate image data 44 and further comprises a set of reception variables for obtaining the transformed image data 30 from the intermediate image data 44. The step of progressively updating the coefficients of transformed image data 30 comprises updating the coefficients by upscaling the intermediate image data 44 repeatedly until the transformed image data 30 is reconstructed substantially losslessly.

Inverse successive approximation is a process in which the transformed image data 30 is reconstructed progressively.

The inverse transformation block 54 comprises an inverse Modified Hadamard Transform basis for extracting reconstructed original image data 18 from the transformed image data 30.

The inverse operation is given by

\hat{X}=Y^{T}AY (7),

where \hat{X} is the reconstructed original image data or image sub block and this function is carried out in inverse transformation block 54. This is the inverse Modified Hadamard Transform for extracting the original image data from the transformed image data. Reconstructing original image data is a process to recover the original image data that was converted into processed image data by another process.

\hat{X}=Y^{T}└A┘Y (8),

This describes the near lossless data reconstructed at the decoder.

The original image data is reconstructed by applying the inverse transformation on the accumulator content (transformed image data) as defined by equation (7).

Then the inverse successive approximation loop counter is incremented by one in the inverse successive approximation loop counter block 64.

j=j+1 (9)

The process is repeated M number times. After M iterations, the rounded off coefficients are transmitted by the encoder and are received by the decoder. The image data reconstructed at the decoder (reconstructed original image data 18) is now the image data reconstructed from the rounded off coefficients, hence not a completely lossless operation. The reconstructed image data is displayed at image display block 66.

Another aspect of the present technique comprises a method of receiving image data which comprises a method for obtaining reconstructed original image data 18 from transformed image data 30; obtaining transformed image data 30 from intermediate image data 44; obtaining intermediate image data 44 from processed image data 16 received from an encoder 12.

Progressive reception is a method of receiving the processed image data 16 and reconstructing the transformed image data 30 such that as the transformed image data 30 is converted into reconstructed original image data 18, the perceptual quality increases.

The benefit of progressive transmission and reception as discussed above with respect to the encoder and decoder is that the rendering of the visual or perceptual quality is gradual. In particular, an image of relatively low resolution is initially obtained.

Successive approximation is a method to obtain the progressive transmission and reception capability. When the transmission channel has less bandwidth and the bits required to transmit exceed the capacity of the channel, the coefficients need to be ordered in such a manner that, at the decoder or receiver, the image data quality increases progressively. However, mere reordering the coefficients may not help in rendering the visual quality at the receiver side because the information is spread across the coefficients. Hence all coefficients need to be ordered at once. This is done by scaling the coefficients to meet the image data constraints of the channel. Progressive reduction in the scaling factor allows for transmitting all coefficients. Thus both requirements of the limited bandwidth and progressive perceptual quality at the receiver side are met.

Preferred embodiments of the present invention can also be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer readable storage medium, wherein when the computer program code is loaded into and executed by a computer, the computer becomes an apparatus for practicing the invention. The present invention can also be embodied in the form of computer program code, for example, whether stored in a storage medium, loaded into or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing the invention. When implemented on a general purpose microprocessor, the computer program code segments configure the microprocessor to create specific logic circuits.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An image data transceiver system comprising:
an encoder for converting original image data into transformed image data, which is converted to intermediate image data and then converted into processed image data, said encoder comprising a forward transformation block, which comprises a Modified Hadamard Transform basis for compressing the original image data, said encoder further comprising a progressive transmission block for progressively transmitting the processed image data; and
a decoder for reconstructing the original image data from the transformed image data, which is obtained from the intermediate image data, the intermediate image data being obtained from the processed image data transmitted from said encoder, said decoder comprising a progressive reconstruction block for progressively reconstructing the transformed image data from the processed image data, said decoder further comprising an inverse transformation block, which comprises an inverse Modified Hadamard Transform basis for obtaining reconstructed original image data from the transformed image data.

2. The image data transceiver system of claim 1, wherein the Modified Hadamard Transform basis comprises a two dimensional basis function constructed from separable one dimensional basis functions, said forward transformation block generating a plurality of coefficients using said Modified Hadamard Transform.

3. The image data transceiver system of claim 1, wherein the inverse Modified Hadamard Transform basis comprises a two dimensional basis function constructed from separable one dimensional basis functions.

4. The image data transceiver system of claim 1, wherein said progressive transmission block comprises:
a forward successive approximation loop for processing the transformed image data and converting it into the intermediate image data, said forward successive approximation loop comprising a set of transmission variables for progressively updating the intermediate image data;
a progressive transmission initialization block for initializing the transmission variables used in the successive approximation loop; and
an entropy encoder for assigning a plurality of bits to the intermediate image data processed by the forward successive approximation loop to convert the intermediate image data into the processed image data.

5. The image data transceiver system of claim 1, wherein said progressive reconstruction block comprises:
an inverse successive approximation loop for progressively reconstructing the transformed image data at said decoder, said decoder comprising an entropy decoder for decoding the processed image data to get the intermediate image data, said inverse successive approximation loop further comprising a set of reception variables for converting back the transformed image data from the intermediate image data; and
a progressive reconstruction initialization block for initializing the reception variables in the inverse successive approximation loop.

6. An encoder for processing original image data and transmitting processed image data, comprising:
a forward transformation block, comprising a Modified Hadamard Transform basis for compressing the original image data and for converting the original image data into transformed image data; and
a progressive transmission block for progressively transmitting the processed image data.

7. The encoder of claim 6, wherein the Modified Hadamard Transform basis comprises a two dimensional basis function constructed from separable one dimensional basis functions, said forward transformation block generating a plurality of coefficients using said Modified Hadamard Transform.

8. The encoder of claim 6, wherein said progressive transmission block comprises:
a forward successive approximation loop for processing the transformed image data and converting it into intermediate image data, said forward successive approximation loop comprising a set of transmission variables for progressively updating the intermediate image data;
a progressive transmission initialization block for initializing the transmission variables used in the forward successive approximation loop; and
an entropy encoder for assigning a plurality of bits to the intermediate image data processed by the forward successive approximation loop to convert the intermediate image data into processed image data.

9. A decoder for obtaining reconstructed original image data, comprising:
a progressive reconstruction block for progressively reconstructing transformed image data from processed image data; and
an inverse transformation block which comprises an inverse Modified Hadamard Transform basis for obtaining reconstructed original image data from the transformed image data.

10. The decoder of claim 9, wherein said progressive reconstruction block comprises:
an inverse successive approximation loop for progressively reconstructing the transformed image data at said decoder, said decoder comprising an entropy decoder for decoding the processed image data to obtain intermediate image data, said inverse successive approximation loop further comprising a set of reception variables for converting back the transformed image data from the intermediate image data; and
a progressive reconstruction initialization block for initializing the reception variables in the inverse successive approximation loop.

11. A method of transmitting original image data comprising:
converting original image data into transformed image data and applying a Modified Hadamard Transform basis to the original image data for compressing original image data;
converting the transformed image data into intermediate image data and using a forward successive approximation loop, comprising a set of transmission variables, for progressively updating the intermediate data;
converting the intermediate image data into processed image data, including applying entropy coding to the intermediate image data originating from the forward successive approximation loop for converting it into the processed image data; and
transmitting said processed image data.

12. The method of claim 11, wherein the step of transmitting the processed image data comprises:
downscaling and updating the coefficients for transmitting the transformed image data progressively in the forward successive approximation loop and converting the transformed image data into the intermediate image data.

13. The method of claim 11, wherein applying the Modified Hadamard Transform basis comprises:
constructing a two dimensional transform basis from two separable one dimensional basis functions.

14. A method of receiving processed image data comprising:
obtaining reconstructed original image data from transformed image data and applying an inverse Modified Hadamard Transform basis for reconstructing the original image data from the transformed image data;
obtaining transformed image data from intermediate image data, including applying entropy decoding to the intermediate image data, progressively updating the coefficients of the intermediate image data by using an inverse successive approximation loop at a decoder, and converting back to transformed image data; and
obtaining intermediate image data from processed image data received from an encoder, including receiving a plurality of coefficients from the processed image data of the encoder.

15. The method of claim 15, wherein the step of progressively updating the coefficients of the intermediate image data comprises:
upscaling the intermediate image data repeatedly until the transformed image data is reconstructed substantially losslessly.

16. A method of transmitting and receiving image data comprising:
transmitting image data, including converting original image data into transformed image data by applying a Modified Hadamard Transform basis to the original image data for compressing the original image data; converting transformed image data into intermediate image and using a forward successive approximation loop comprising a set of transmission variables for progressively updating the intermediate data; converting the intermediate image data into processed image data, including applying entropy coding to the intermediate image data originating from a forward successive approximation loop for converting it into the processed image data; and for transmitting said processed image data; and
reconstructing the original image data from the transformed image data, including applying an inverse Modified Hadamard Transform basis for obtaining reconstructed original image data from the transformed image data; obtaining the transformed image data from intermediate image data, including progressively updating the coefficients of intermediate image data by using an inverse successive approximation loop at a decoder; and obtaining intermediate image data from processed image data received from an encoder by receiving a plurality of coefficients and applying entropy decoding to the processed image data received from the encoder.

17. A storage medium encoded with machine-readable computer program code for including instructions for causing a computer to implement a method comprising:
transmitting image data, including converting original image data into transformed image data by applying a Modified Hadamard Transform basis to the original image data for compressing the original image data; converting transformed image data into intermediate image and using a forward successive approximation loop comprising a set of transmission variables for progressively updating the intermediate data; converting the intermediate image data into processed image data, including applying entropy coding to the intermediate image data originating from a forward successive approximation loop for converting it into the processed image data; and for transmitting said processed image data; and
reconstructing the original image data from the transformed image data including applying an inverse Modified Hadamard Transform basis for obtaining reconstructed original image data from the transformed image data; obtaining the transformed image data from intermediate image data, including progressively updating the coefficients of intermediate image data by using an inverse successive approximation loop at a decoder; and obtaining intermediate image data from processed image data received from an encoder by receiving a plurality of coefficients and applying entropy decoding to the processed image data received from the encoder.

18. A storage medium encoded with machine-readable computer program code for including instructions for causing a computer to implement a method comprising:
transmitting image data, including converting original image data into transformed image data by applying a Modified Hadamard Transform basis to the original image data for compressing the original image data; converting transformed image data into intermediate image and using a forward successive approximation loop comprising a set of transmission variables for progressively updating the intermediate data; converting the intermediate image data into processed image data, including applying entropy coding to the intermediate image data originating from a forward successive approximation loop for converting it into the processed image data; and for transmitting said processed image data.

19. A storage medium encoded with machine-readable computer program code for including instructions for causing a computer to implement a method comprising:
reconstructing original image data from transformed image data including applying an inverse Modified Hadamard Transform basis for obtaining reconstructed original image data from the transformed image data; obtaining the transformed image data from intermediate image data, including progressively updating the coefficients of intermediate image data by using an inverse successive approximation loop at a decoder; and obtaining intermediate image data from processed image data received from an encoder by receiving a plurality of coefficients and applying entropy decoding to the processed image data received from the encoder.
